(19) United States
(12) Patent Application Publication
(10) Pub. No.: US 2026/0349411 A1
(43) Pub. Date: Nov. 5, 2026

(54) MACHINE TOOL

(71) Applicant: FANUC CORPORATION, Minamitsuru-gun, Yamanashi (JP)

(72) Inventor: Taisei FUJIMOTO, Minamitsuru-gun, Yamanashi (JP)

(21) Appl. No.: 19/101,777

(22) PCT Filed: Oct. 21, 2022
(86) PCT No.: PCT/JP2022/039388

§ 371 Date: Feb. 6, 2025

(51) Int. Cl. G05B 19/4155

(52) U.S. Cl. CPC G05B 19/4155; G05B 2219/49205

(57) ABSTRACT

A machine tool according to one aspect of the present disclosure is provided with: a plurality of servo motors; a plurality of servo amplifiers that respectively drive the servo motors; and a control device that inputs a command value to the plurality of servo amplifiers according to a machining program, wherein the control device has a safety information acquisition unit that acquires safety information indicating the safety on excitation stop of the servo motors, and a stop control unit that, when the machining program is not running, stops the excitation of the servo motors indicated to be safe by the safety information.

### TECHNICAL FIELD

The present invention relates to a machine tool.

### BACKGROUND ART

A machine tool machines a workpiece by operating a plurality of servo motors in cooperation with each other. In general, the servo motors correspond to servo amplifiers on a one-to-one basis and are each driven by a current supplied from the corresponding servo amplifier. Each servo motor is excited even when its output shaft is not to be displaced, and the output is adjusted such that a rotational position of the servo motor coincides with a target position on each occasion.

As described above, the servo motors of a machine tool are normally always in a state of excitation and consume electric power. An exception is the occurrence of a power failure or the like. In order to prevent a feed shaft from colliding (interfering with another shaft or the limit of a range of motion) in the case of a power failure or the like, a technique has been proposed in which power supply to a servo motor is interrupted when an abnormality is detected (for example, see Patent Document 1).

### CITATION LIST

### Patent Document

Patent Document 1: Japanese Unexamined Patent Application, Publication No. 2014-96929

### DISCLOSURE OF THE INVENTION

### Problems to be Solved by the Invention

In recent years, there has been an increasing demand for energy conservation, and machine tools are required to be more energy efficient. Therefore, a technique capable of reducing power consumption of a servo motor is desired.

### Means for Solving the Problems

A machine tool according to an aspect of the present disclosure includes: a plurality of servo motors; a plurality of servo amplifiers that drive the plurality of servo motors, respectively; and a controller that inputs command values to the plurality of servo amplifiers in accordance with a machining program. The controller includes a safety information acquisition unit that acquires safety information indicating a level of safety with respect to stopping excitation of the servo motors, and a stop control unit that stops excitation of one more of the servo motors that is/are indicated as safe by the safety information, when the machining program is not executed.

### BRIEF DESCRIPTION OF THE DRAWINGS

FIG. 1 is a block diagram illustrating a configuration of a machine tool according to an embodiment of the present disclosure.

### PREFERRED MODE FOR CARRYING OUT THE INVENTION

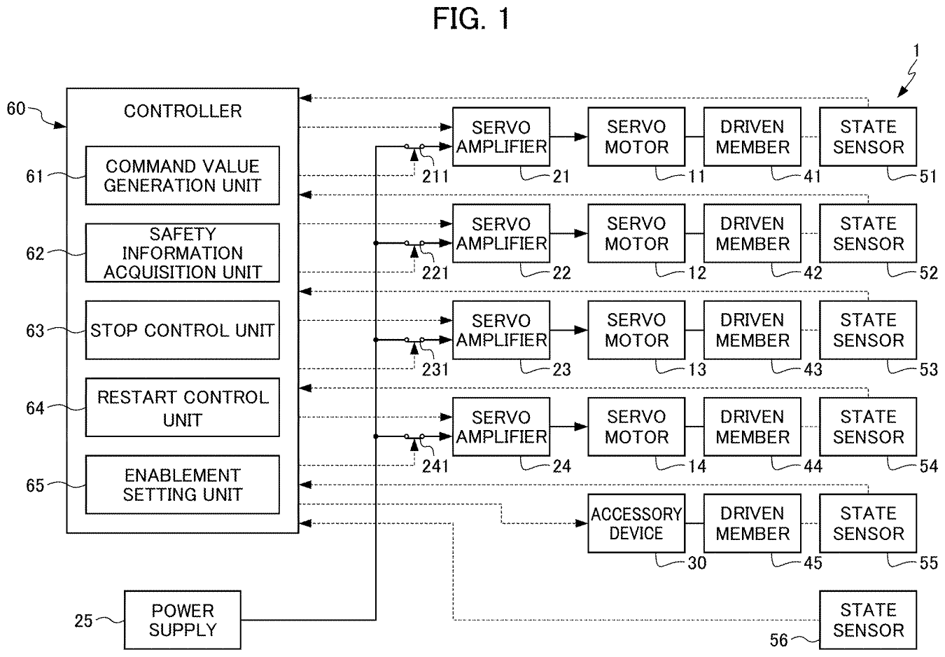

Embodiments of the present disclosure will be described below with reference to the drawings. FIG. 1 is a schematic diagram illustrating a configuration of a machine tool 1 according to an embodiment of the present disclosure.

The machine tool 1 includes: a plurality of servo motors 11, 12, 13, and 14; a plurality of servo amplifiers 21, 22, 23, and 24 that drive the servo motors 11, 12, 13, and 14, respectively; one or more accessory devices 30 that are not servo-driven; driven members 41, 42, 43, 44, and 45 that are respectively driven by the servo motors 11, 12, 13, and 14 or the accessory devices 30; a plurality of state sensors 51, 52, 53, 54, 55, and 56 that detect a level of safety with respect to stopping the excitation of the servo motors 11, 12, 13, and 14; and a controller 60 that inputs command values to the plurality of servo amplifiers 21, 22, 23, and 24 in accordance with a machining program.

The servo motors 11, 12, 13, and 14 may include a spindle motor that relatively rotates a tool and a workpiece, a plurality of positioning shaft motors that relatively move a tool and the workpiece, a servo motor that drives a peripheral device such as a door or the like, and any other motor.

Although FIG. 1, which is a schematic diagram, illustrates the four servo motors 11, 12, 13, and 14 and the four servo amplifiers 21, 22, 23, and 24, the number of servo motors and that of servo amplifiers are not limited and are usually greater than four in practice.

The servo amplifiers 21, 22, 23, and 24 are provided in correspondence with the servo motors 11, 12, 13, and 14 on a one-to-one basis, and each supply an excitation current for exciting a winding of the corresponding one of the servo motors 11, 12, 13, and 14. The servo amplifiers 21, 22, 23, and 24 may be configured to regulate the currents to be inputted to the servo motors 11, 12, 13, and 14 so that the respective speeds of the servo motors 11, 12, 13, and 14 are adjusted to the speeds indicated by the command values inputted from the controller 60.

Each of the servo amplifiers 21, 22, 23, and 24 is supplied with electric power from a power supply 25. The electric power from the power supply 25 is supplied to the servo amplifiers 21, 22, 23, and 24 via electric circuits respectively provided with primary breakers 211, 221, 231, and 241 that are operated by the controller 60.

The servo amplifiers 21, 22, 23, and 24 are configured to interrupt their outputs to thereby stop the excitation of the servo motors 11, 12, 13, and 14 in response to an input of a stop signal from the controller 60. The mechanism for stopping the excitation may be a secondary breaker capable of disconnecting an electric circuits via which the main bodies of the servo amplifiers 21, 22, 23, and 24 are connected to the servo motors 11, 12, 13, and 14.

Furthermore, the servo amplifiers 21, 22, 23, and 24 may be configured to stop communication in accordance with the value of a communication control signal inputted from the controller 60, and are preferably configured to slow the communication in accordance with a communication control signal inputted from the controller 60.

The accessory devices 30 include one or more devices that consume electric power, and examples thereof include a door opening/closing motor, a hydraulic pump, a cooling fan, a refrigerator, an air compressor, a light, a display device, and the like that are not servo-driven. The accessory devices 30 can be controlled by the controller 60 via, for example, a relay circuit (not shown) or the like.

The driven members 41, 42, 43, 44, and 45 are driven by the servo motors 11, 12, 13, and 14 or the accessory devices 30. Specific examples of the driven members 41, 42, 43, 44, and 45 include a tool chuck, a work holding table, a door panel, etc. The driven members 41, 42, 43, 44, and 45 may include other servo motors 11, 12, 13, and 14 in order to perform multiaxial positioning.

The state sensors 51, 52, 53, 54, 55, and 56 may be configured to detect an operation state (position, posture, etc.) of the driven members 41, 42, 43, 44, 45 or a manually operable safety cover, etc. Furthermore, the state sensors 51, 52, 53, 54, 55, and 56 may be a sensor that checks the absence of a person or object in a specific space. The state sensors 51, 52, 53, 54, 55, and 56 may be, for example, a phototube, a limit switch, or the like.

The controller 60 can be implemented by one or more computer devices each include, for example, a memory, a processor (CPU), an input/output interface, and the like, and execute an appropriate control program. Specifically, the controller 60 may be a numerical controller, a programmable logic controller, or a personal computer, for example. The controller 60 includes a command value generation unit 61, a safety information acquisition unit 62, a stop control unit 63, a restart control unit 64, and an enablement setting unit 65. The foregoing constituent elements of the controller 60 refer to categorized functions of the controller 60, and do not have to be clearly distinguishable from each other in terms of physical configuration and program configuration.

The command value generation unit 61 generates command values to be inputted to the servo amplifiers 21, 22, 23, and 24 based on a machining program. The command value generation unit 61 may be configured to correct the command values to be inputted to the servo amplifiers 21, 22, 23, and 24 in consideration of feedback signals indicating actual speeds of the servo motors 11, 12, 13, and 14.

The safety information acquisition unit 62 acquires one or a plurality of pieces of safety information indicating a level of safety with respect to stopping the excitation of the servo motors 11, 12, 13, and 14. Each of the pieces of the safety information may indicate a level of safety of one or more of the servo motors 11, 12, 13, and 14. The plurality of pieces of safety information may indicate a level of safety of one of the servo motor 11, 12, 13, and 14. In the case where the plurality of pieces of safety information indicate a level of safety of one of the servo motors 11, 12, 13, and 14, a state in which all of the plurality of pieces of safety information have a value indicating an adequate level of safe can be considered to indicate that the safety can be ensured even when excitation of the one of the servo motors 11, 12, 13, and 14 is stopped. The term “level of safety with respect to stopping the excitation” means that no hazard is considered to be caused even in a case where one or more of the driven members 41, 42, 43, and 44 are lowered due to loss of torque against gravity, in a case where overshoot of one or more of the driven members 41, 42, 43, and 44 occurs due to loss of braking force, and in a similar case. The safety information preferably includes detection values of the state sensors 51, 52, 53, 54, 55, and 56, and may further include information regarding encoders of the servo motors 11, 12, 13, and 14, brake operation information of the servo motors 11, 12, 13, and 14 having brakes, a state of a manual switch operated by a user, and the like.

The stop control unit 63 stops the excitation of one or more of the servo motors 11, 12, 13, and 14 that is/are indicated as safe by the safety information, when the machining program is not executed. Specifically, in a case where based on the safety information, one or more of the servo motors 11, 12, 13, and 14 is/are determined as safe even if the excitation is stopped, the stop control unit 63 causes one or more of the servo amplifiers 21, 22, 23, and 24 to stop outputting the excitation current to the one or more of the servo amplifiers 21, 22, 23, and 24. This configuration makes it possible to reduce power consumption of the servo motors 11, 12, 13, and 14 while the machining program is not executed.

When the excitation of one or more of the servo motors 11, 12, 13, and 14 is stopped, the stop control unit 63 preferably displays the stop of the excitation such that the user can check the stop of the excitation.

In addition to causing the servo amplifiers 21, 22, 23, and 24 that drive the servo motors 11, 12, 13, and 14 to stop outputting the excitation current, the stop control unit 63 may interrupt the supply of electric power to the servo amplifiers 21, 22, 23, and 24, that is, may open the primary breaker 211, 221, 231, and 241. This configuration makes it possible to further reduce power consumption.

The stop control unit 63 may interrupt or slow the communication of one or more of the servo amplifiers 21, 22, 23, and 24 that drive one or more of the servo motors 11, 12, 13, and 14 that is/are indicated as safe by the safety information. This configuration makes it possible to reduce power consumption for communication of the servo amplifiers 21, 22, 23, and 24, as well.

The stop control unit 63 may interrupt the power supply to the accessory devices 30 associated in advance with the servo motors 11, 12, 13, and 14, in synchronization with the stop of excitation of the servo motors 11, 12, 13, and 14.

Examples of the device the power supply to which can be interrupted in synchronization with the stop of excitation of the servo motors 11, 12, 13, 14 include a display device for displaying information regarding the servo motors 11, 12, 13, and 14, illumination devices for improving visibility of the servo motors 11, 12, 13, 14, the driven members 41, 42, 43, 44, 45, etc., a cooling fan for cooling the servo motors 11, 12, 13, 14, and the like.

The restart control unit 64 monitors values detected by the state sensors 51, 52, 53, 54, 55 and 56 while the excitation of one or more of the servo motors 11, 12, 13, and 14 is stopped by the stop control unit 63. The restart control unit 64 causes the stop control unit 63 to restart the excitation of one or more of the servo motors 11, 12, 13, and 14 when it is determined, based on the values detected by the state sensor 51, 52, 53, 54, 55, and 56, that a state has brought about in which the stop of excitation of the one or more the servo motors 11, 12, 13, and 14 causes a hazard.

The enablement setting unit 65 enables and disables the stop control unit 63 in accordance with an external signal. In a case where the execution of a machining program starts while the excitation of one or more of the servo motors 11, 12, 13, and 14 is stopped by the stop control unit 63, there may be a waiting time before the excitation of the one or more of the servo motors 11, 12, 13, and 14 restarts. Therefore, in a case where a machining program is executed at short intervals, for example, the stop control unit 63 is disabled by an external signal from a management computer or the like, so that a decrease in the operation rate can be prevented.

As described above, since the machine tool 1 includes the stop control unit 63 that stops one or more of the excitation of the servo motors 11, 12, 13, and 14 when a machining program is not executed, power consumption due to the excitation of the servo motors 11, 12, 13, and 14 can be reduced.

The following additional remarks are further disclosed in relation to the above-described embodiments and modifications.

### Additional Remark 1

A machine tool (1) includes: a plurality of servo motors (11, 12, 13, 14) ; a plurality of servo amplifiers (21, 22, 23, 24) that drive the plurality of servo motors (11, 12, 13, 14), respectively; and a controller (60) that inputs command values to the plurality of servo amplifiers (21, 22, 23, 24) in accordance with a machining program. The controller (60) includes a safety information acquisition unit (62) that acquires safety information indicating a level of safety with respect to stopping the excitation of the servo motors (11, 12, 13, 14), and a stop control unit (63) that stops excitation of one or more of the servo motors (11, 12, 13, 14) that is/are indicated as safe by the safety information, when the machining program is not executed.

### Additional Remark 2

The stop control unit (63) may interrupt power to one or more of the servo amplifiers (21, 22, 23, 24) that drive one or more of the servo motors (11, 12, 13, 14) that is/are indicated as safe by the safety information.

### Additional Remark 3

The stop control unit (63) may stop or slow communication of one or more of the servo amplifiers (21, 22, 23, 24) that drive one or more of the servo motors (11, 12, 13, 14) that is/are indicated as safe by the safety information.

### Additional Remark 4

The machine tool (1) may further include a state sensor (51, 52, 53, 54) that detects an operation state of one or more members (41, 42, 43, 44) driven by the servo motors (11, 12, 13, 14).

### Additional Remark 5

The controller (60) may further include a restart control unit (64) that restarts the excitation of one or more of the servo motor (11, 12, 13, 14) based on a value detected by the state sensor (51, 52, 53, 54).

### Additional Remark 6

The controller (60) may further include an enablement setting unit (65) that enables and disables the stop control unit (63) in accordance with an external signal.

### Additional Remark 7

The stop control unit (63) may display stop of the excitation when the excitation of one or more of the servo motors (11, 12, 13, 14) is stopped.

### Additional Remark 8

The stop control unit (63) may interrupt power supply to another device (30) in synchronization with stop of the excitation of one or more of the servo motors (11, 12, 13, 14).

In the foregoing, the present disclosure has been described in detail. It should be noted that the present disclosure is not limited to the individual embodiments described above. Various additions, substitutions, modifications, partial deletions, and the like can be made to the above embodiments without departing from the spirit of the present disclosure or the spirit of the present disclosure derived from the matters described in the claims and the equivalents thereof.

For example, the accessory devices are not essential to the machine tool according to the present disclosure, and the state sensors that detect the operation states of the driven members that are not driven by the servo motors are also optional components. For example, the machine tool according to the present disclosure may include another component for achieving energy conservation, such as a component for activating a screen saver and a component for turning off a pump, independently of the stop control unit.

### EXPLANATION OF REFERENCE NUMERALS

1: Machine tool
11, 12, 13, 14: Servo motor
21, 22, 23, 24: Servo amplifier
211, 221, 231, 241: Primary breaker
212, 222, 232, 242: Relay
25: Power supply
30: Accessory device
41, 42, 43, 44, 45: Driven member
51, 52, 53, 54, 55, 56: State sensor
60: Controller
61: Command value generation unit
62: Safety information acquisition unit
63: Stop control unit
64: Restart control unit
65: Enablement setting unit

1. A machine tool comprising:
a plurality of servo motors;
a plurality of servo amplifiers that drive the plurality of servo motors, respectively; and
a controller that inputs command values to the plurality of servo amplifiers in accordance with a machining program,
the controller comprising
a safety information acquisition unit that acquires safety information indicating a level of safety with respect to stopping excitation of the servo motors, and
a stop control unit that stops excitation of one or more of the servo motors that is/are indicated as safe by the safety information, when the machining program is not executed.

2. The machine tool according to claim 1, wherein
the stop control unit interrupts power to one or more of the servo amplifiers that drive one or more of the servo motors that is/are indicated as safe by the safety information.

3. The machine tool according to claim 1, wherein
the stop control unit stops or slows communication of one or more of the servo amplifiers that drive the one or more of the servo motors that is/are indicated as safe by the safety information.

4. The machine tool according to claim 1, further comprising:
a state sensor that detects an operation state of one or more members driven by the servo motors.

5. The machine tool according to claim 4, wherein
the controller further comprises a restart control unit that restarts the excitation of one or more of the servo motors based on a value detected by the state sensor.

6. The machine tool according to claim 1, wherein
the controller further comprises an enablement setting unit that enables and disables the stop control unit in accordance with an external signal.

7. The machine tool according to claim 1, wherein
the stop control unit displays stop of the excitation when the excitation of one or more of the servo motors is stopped.

8. The machine tool according to claim 1, wherein
the stop control unit interrupts power supply to another device in synchronization with stop of the excitation of one or more of the servo motors.
